(19) United States
(12) Patent Application Publication
(10) Pub. No.: US 2017/0293939 A1
(43) Pub. Date: Oct. 12, 2017

(54) SOCIAL SPONSOR METHOD USING A SOCIAL NETWORK SERVICE AND CREDIT CARD PAYMENT INFORMATION

(71) Applicant: SUK HWAN YEOM, SEOUL (KR)

(72) Inventor: SUK HWAN YEOM, SEOUL (KR)

(21) Appl. No.: 15/516,426

(22) PCT Filed: Sep. 30, 2015
(86) PCT No.: PCT/KR2015/010337

§ 371 Date: Apr. 3, 2017

(30) Foreign Application Priority Data
Oct. 1, 2014 (KR) 10-2014-0132313

(51) Int. Cl. G06Q 30/02; G06Q 20/34; G06F 17/30; G06Q 50/00

(52) U.S. Cl. CPC G06Q 30/0267; G06Q 50/01; G06Q 20/341; G06F 17/30289; G06Q 30/0273

(57) ABSTRACT

A social sponsor method using a social network service and credit card payment information is provided. The method includes approving use of member information; providing purchaser information; identifying the member of the social network service; providing personal connection information of the purchaser; making social sponsor group by member stores; permitting sponsor authority; and implementing social sponsorship such that novel sponsorship culture can take root through sustained sponsor and living of sponsor, a specific network between a merchandiser (member store) and a sponsor can be composed and simultaneously a network among sponsors as well as between the merchandiser and a recipient can be composed, and reputation and sales amount of the merchandiser can be improved by sponsorship

### TECHNICAL FIELD

The present invention relates to a social sponsor method, and more particularly, relates to a sponsor method linking with credit card payment information on member stores and personal connections information of social network service members, based on personal connection information of a social network service.

### BACKGROUND ART

A social donation denotes a kind of donations using a SNS (Social Network Service) in which participation is encouraged by a campaign through members of a social network service and a personal connections of the member.

A typical method is that goods or money are contributed if someone writes a reply on the Facebook or retweets on the Twitter.

When a company applies the social donation on marketing, consumers feel satisfaction by directly joining in the social donation process and likability of the company or brands may be increased. However, there is a limit to raise spontaneous donation culture because the social donation is performed as an event for the members of the social network service to be just one-off event for a company or a promotion.

In a conventional social donation, a donator cannot choose a person to contribute, the goods and money are contributes to just social weakness or neglected class of people, and contribution of goods and money is unclear thereby limiting to raise uninhibited and spontaneous donation culture.

Further, a donator and a recipient does not connect each other and even if donators are not connected to form a network.

The conventional social donation was just one-off event and limit to raise new donation culture because of the above problems.

Furthermore, a business operator who is selling products or services to make a profit has put an advertisement using a public TV, a cable TV, a radio, a newspaper or several magazines as shown in FIG. 1 to attract customers, however, methods of marketing advertisement such as a keyword ad, a banner ad in a search engine, a specific site ad, an email ad, a popup ad, an event ad, an overture ad, a community ad and a gift ad are diversifying by Internet penetration such that a burden of advertisement cost are increased and product price are also increased to shift the advertisement cost onto the consumer.

Recently, a social commerce has been introduced as a new marketing method, in which a merchandiser can reduce a cost of advertisement and a consumer can buy more cheaply a product. In contrast, the social commerce has a limitation that an online site such as a shopping mall should be constructed, consumers should announce products of the merchandiser through a social network to achieve specific purchasing amount. Therefore, the social commerce has a limitation of one-off characteristics not to be applied onto universal products or services continuously.

In a position of consumer, a choice is restricted to products or services which are suggested by a merchandiser.

And, in a position of merchandiser, sales is just increased in proportion to the number of purchaser, however, any network is made among the merchandiser and purchasers.

An online shopping mall connecting consumption and donation has been announced by Korea Patent Application No. 10-2008-0051053, “METHOD FOR ASSOCIATING WITH SERVICE IN UNIFIED ONLINE SHOPPING MALL”.

This conventional art relates to a service promotion on a unified online shopping mall service system and a method of service alliance for promoting donation culture.

The unified online shopping mall service system includes a donation manager, a donation DB and a call center, a registered enterprise member who receives a product supplier mall through a main homepage of a unified shopping mall main domain and a regular member of a wholesales mall and a retail mall who receives a client shopping mall through the main homepage of the main domain is able to be registered as donation members.

The system provides an environment where the registered donation member can contribute a portion of sales amount as donation money for recipients or contribute goods to be donated as donation goods for the recipients. The donation member can be backed up a delivery vehicle controlled by the call center to provide the donation goods within shelf life. A public proceeds may be provided as a compensation of the donation, or a solution of an affiliated website or a unified shopping mall be provided as a compensation of the donation. Also, a unified member management may be supported by the system.

The conventional art provides an environment where the registered donation member can contribute a portion of sales amount as donation money for recipients or contribute goods to be donated as donation goods for the recipients such that a donation can be associated with an online shopping mall to promote the unified shopping mall and the donation culture, however, the problems of the social donation described above are remained.

Particularly, the donator (the enterprise member or the registered member who operates an online shopping mall), the recipient and the purchaser cannot be made any specific relationship, and marketing efficient is insignificant because the donation is not personalized.

To solve the above problem, another conventional art may be disclosed by a Korea patent application No. 10-2000-0052868, “Donation system and the method using feedback mailing on electronic commerce”

This conventional art associates a donation system with an online business such as an online commerce such that gift money received by the online electronic commerce is contributed to at least one recipient from a preselected recipient list. The recipient sends present condition and a mail directly or indirectly to the donator such that an initial donator is encouraged to donate and customer's interest is raised to increase sales amount. This conventional art relates to a method of online associating the donation with the shopping mall contributing a portion of the sales amount.

In a supporters' site, it is difficult to bring a donator sustained interest because donation money is just contributed and any feedback is not raised, thereby the donation was just one-off thing. In contrast, in this conventional art, the donator performs commercial action and contributes a portion of benefit money toward a person whom the donator wants to help thereby simultaneously achieving purposes of good deeds and shopping.

Further, the growth of recipient is continuously recorded on the site, and recipient represents attribution to the donator by a notification, a mail, a letter, a telephone and etc. Therefore, the donator is concerned about the recipient and continuously conducts the online commerce.

However, this conventional art also has a limitation such that new donation culture cannot be formed because the donator and the recipient make a predetermined relationship but the relationship is not personal relationship, restricted within online shopping and the donation is conducted by choosing preselected recipients.

In summary, the conventional donation culture does not provide desirable donation culture in which spontaneous donation is conducted in everyday life because the neglected class of people or social weakness are classified as recipients and the donation is conducted as one-off event. And, the donation according to consumption has problems of restrictive and closed because the donation is conducted within members in a specific site such as an online shopping mall.

### DISCLOSURE

### Technical Problem

Embodiments of the inventive concept are intended to solve the problems of the conventional art described above and to provide a social sponsor method in which contributions are supplied to a recipient assigned by a donator, the contributions are accumulated by consumption of members in personal connection information of a sponsor's social network service based on information of social sponsor group which is marketing target group having high efficiency in contradiction to marketing cost of on/offline member stores.

Embodiments of the inventive concept are intended to provide a social sponsor method in which anyone can be a sponsor and a recipient by consuming on a member store.

Embodiments of the inventive concept are intended to provide a social sponsor method in which a specific network can be made between a merchandiser (member store) and a sponsor, and among the sponsors as well as between a merchandiser and recipient, simultaneously.

Embodiments of the inventive concept are intended to provide a social sponsor method capable of increasing reputation and sale amount of a member store through donation.

Embodiments of the inventive concept are intended to provide a social sponsor method in which a donation is conducted through a consumption group of a member store according to personal connection in a sponsor's social network service.

Embodiments of the inventive concept are intended to provide a social sponsor method in which a right of sponsorship is provided as a compensation of publicity between purchasers affiliated with social sponsor group of each member store, thereby being established new donation culture by sustained sponsorship and living of sponsorship

Embodiments of the inventive concept are intended to provide a social sponsor method capable of increasing purchaser's re-purchase rate through the social donation conducted by consumption on a member store, encouraging the purchaser to be aggressive in publicity about the merchandiser through personal relationship on an online, thereby making sponsorship a way of life in everyday life.

### Technical Solution

Embodiments of the inventive concept provide social sponsor methods using a social network service and credit card payment information including: a step of approving use of member information in which a social network service server providing a social network service obtains an approval for using information necessary to a social sponsor from members of the social network service; a step of providing purchaser information in which a credit card company server obtains credit card payment information from a credit card payment device installed in a member store and transfers the purchaser information to the social sponsor server; a step of identifying the member of the social network service in which the social sponsor server associates with the social network service server and requests identification of the social network service server whether the purchaser is a member of the social network service; a step of providing personal connection information of the purchaser in which the social network service server transfers the personal connection information to the social sponsor server if the purchaser is identified as a member; a step of making social sponsor group by member stores in which the social sponsor server associates with the credit card company server to identify the member of the social network service contained in the personal connection information received from the social network service server as a member of the credit card company; a step of permitting sponsor authority in which the social sponsor server accumulates advertising compensation into a purchaser's sponsor account, and provides the purchaser with the sponsor authority, wherein the advertising compensation provided by a member store to the purchaser when sales amount arises by a credit card payment in the social sponsor group of each member store; and a step of implementing social sponsorship in which the purchaser having the sponsor authority selects a recipient through the social sponsor server and the social sponsor server assists the recipient selected by the purchaser in accordance with the sponsor authority of the purchaser.

In some embodiments, the social network service server may be a plurality of social network service servers providing variety of social network services; and the social sponsor server may receive personal connection information of the purchaser from a plurality of the social network service servers.

In other embodiments, a credit card payment device in the step of providing purchase information may include at least one of a credit card terminal, a point of sales (POS) system and an internet credit card payment application.

In still other embodiments, the step of making a social sponsor group by member stores may further include that the social sponsor server generates the social sponsor group of purchasers by member stores to construct a database of a social sponsor group information and transfers the database of social sponsor group information to a credit card company members and member stores in the social sponsor group through the social sponsor server, the database.

In even other embodiments, the advertisement compensation in the step of permitting sponsor authority may be decided based on total purchasing amount of the social sponsor group in the member store during predetermined period.

In yet other embodiments, in the step of implementing social sponsorship, the purchaser may designate a plurality of recipients through the social sponsor server and may set sponsorship rates of the recipients such that sponsorship is implemented in accordance with the sponsorship rate.

In further embodiments, in the step of implementing social sponsorship, sponsorship money may be settled the credit card payments of the recipient if the recipient is a member of a credit card company.

In still further embodiments, in the step of implementing social sponsorship, information of advertisement for sponsors which is provided by the recipient in order to invite sponsors may be provided to the purchasers through the social sponsor server.

In even further embodiments, in the step of implementing social sponsorship, information of advertisement for sponsors may be provided to other purchasers in order to invite sponsors for a recipient designated by certain sponsor.

The information of the advertisement for sponsors may be transferred to mobile terminals of purchasers from the social sponsor server.

In even further embodiments, in the step of implementing social sponsorship, accumulation information of a sponsor's account and sponsorship information for the recipient designated by the purchaser may be provided to the purchaser's mobile terminal through the social sponsor server in real time.

In even further embodiments, in the step of implementing social sponsorship, a purchaser may specify condition for recipients through the social sponsor server, and the social sponsor server may link the purchaser and a sponsorship requester in accordance with the specified condition for the recipients to provide the purchaser with information of the sponsorship requester.

### Advantageous Effects

According to embodiments of the inventive concept, advertisement compensation by credit card member stores is changed into sponsorship money such that new authority concept having sponsorship authority instead of personal money is generated and new sponsorship culture using a social network instead of one-way contribution is also generated.

According to embodiments of the inventive concept, the sponsor and the recipient conduct social activation not with one-way relationship or ‘1 to 1’ relationship but with a ‘many to many’ concept.

According to embodiments of the inventive concept, the member store is associated with sponsorship such that use of the member store connects with social activation of users to generate and concrete marketing of storytelling image spontaneously.

Embodiments of the inventive concept may be applied to the variety of online/offline member stores, and members who belong in sponsor's personal connections of a social network service accumulate sponsorship money by consuming at the member store to contribute the recipient who is designated by the sponsor, based on information of a social sponsor group with relatively high efficiency in compare with marketing cost by the online/offline member stores

According to embodiments of the inventive concept, novel sponsor method is provided such that anyone can be a sponsor or a recipient by consuming at the member store.

According to embodiments of the inventive concept, a specific network between a merchandiser (member store) and a sponsor can be composed and simultaneously a network among sponsors as well as between the merchandiser and a recipient can be composed.

According to embodiments of the inventive concept, a network of a social sponsor group is composed such that reputation and sales amount of the merchandiser can be improved by sponsorship.

A sponsor authority is granted to purchasers composing a social sponsor group formed by member stores such that novel sponsorship culture can take root through sustained sponsor and living of sponsor.

According to embodiments of the inventive concept, repurchasing rate of existing purchaser is increased with a social sponsor conducted by consumption at a member store and a purchaser is encouraged to conducting aggressive advertisement for merchandizing through personal relationship on online such that sponsorship becomes a way of daily life.

According to embodiments of the inventive concept, a marketing target who is directly related with purchasing in view of a merchandiser (member store) can be found out easily, purchasers with high royalty can be formed and aggressive advertisement can be induced through existing purchaser's personal connections on online.

According to embodiments of the inventive concept, in view of a credit card company, use of credit cards can be increased with composing a social sponsor group using its credit cards and members of its credit cards can be also increased.

### DESCRIPTION OF DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept, in the drawings:

FIG. 1 is a drawing for illustrating the stream of customer inflow through the conventional marketing method;

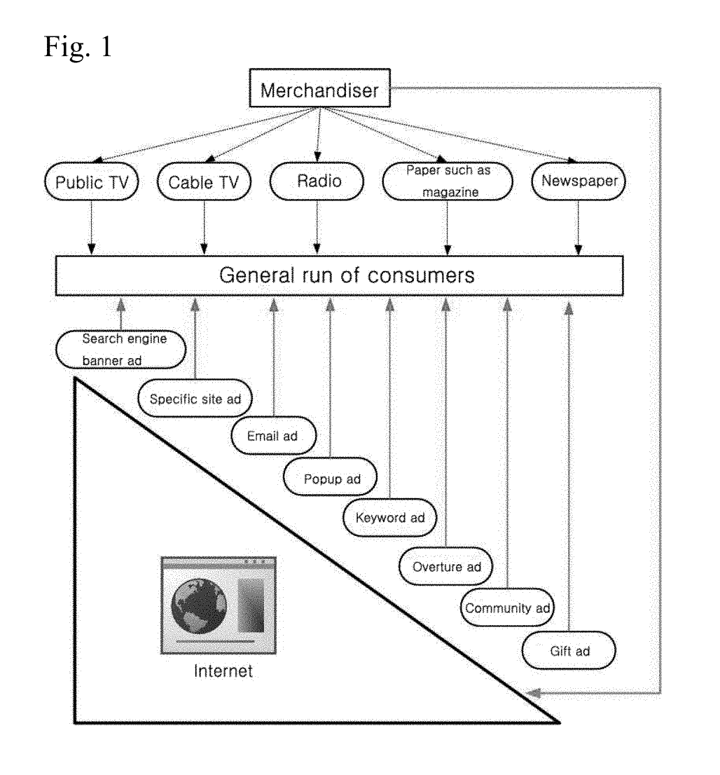

FIG. 2 is a drawing for illustrating an example of analyzing purchaser's network to a merchandizer;

FIG. 3 is a drawing for illustrating a basic concept of a social sponsor method by member stores using personal connections of a social network service and credit card payment information;

FIG. 4 is a drawing for illustrating a sequence of a social sponsor method by member stores using personal connections of a social network service and credit card payment information;

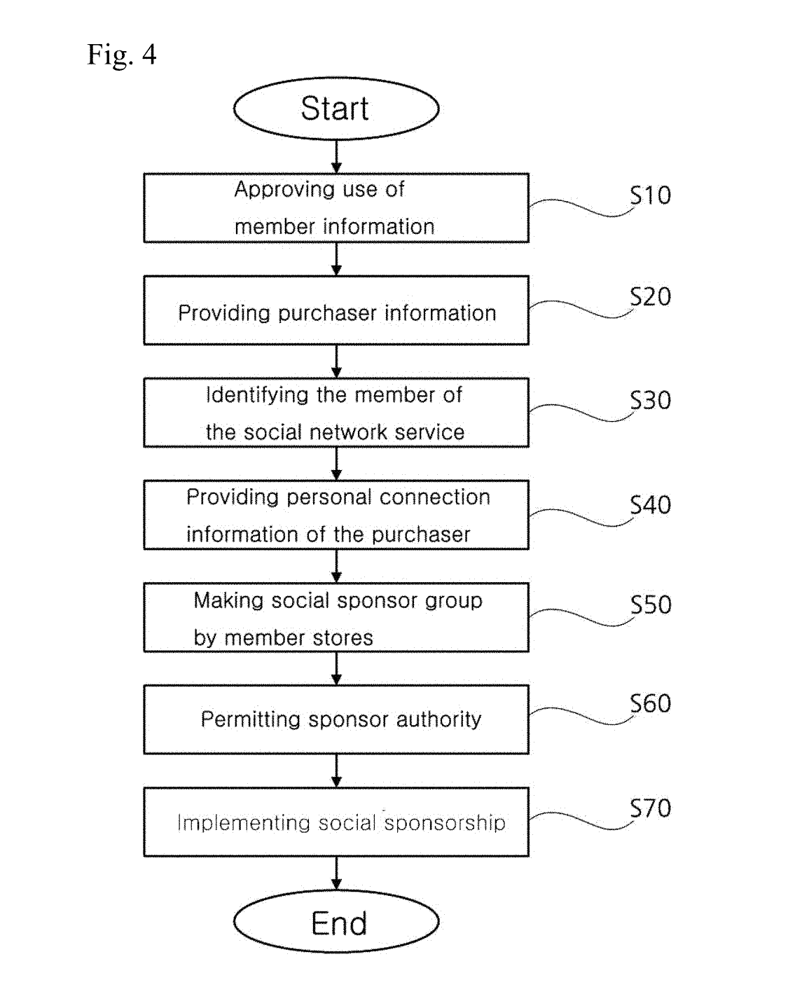

FIG. 5 is a drawing for illustrating a composing a social sponsor group of a social sponsor method by member stores using personal connections of a social network service and credit card payment information; and

FIG. 6 is a drawing for illustrating a specific process to compose a social sponsor group of a social sponsor method by member stores using personal connections of a social network service and credit card payment information.

### MODE FOR INVENTION

Advantages and characteristics of the inventive concept, and implementable representations thereof will be clearly understood with exemplary embodiments that are described below in more detail with reference to the accompanying drawings. However, the inventive concept may be embodied in different forms and should not be construed as limited to the embodiments set forth herein. Rather, these embodiments are provided so that this disclosure will be thorough and complete, and will fully convey the scope of the inventive concept to those skilled in the art. The inventive concept may be merely defined with the scope of claims. Like reference numerals refer to like elements throughout the description.

It will also be understood herein that when a layer such as a conductive layer, a semiconductor layer or an insulating layer is referred to as being “on” another layer or substrate, the layer may be directly on the another layer or substrate, or intervening layers may also be present. It will also be understood that, although the terms such as a first, a second, a third, etc. may be used herein to describe layers or processes, the layers or processes should not be limited by these terms. These terms are only used to distinguish one layer or process from another layer or process.

All terms used herein are to describe the inventive concept that should not be limited by these terms. As used herein, the singular forms are intended to include the plural forms as well, unless the context clearly indicates otherwise. It also will be understood that, as used herein, the term “comprises” and/or “comprising” is open-ended, and includes one or more stated constituents, steps, actions and/or elements without precluding one or more unstated constituents, steps, actions and/or elements.

Furthermore, embodiments in the detailed description will be described with sectional views and/or plan views as ideal exemplary views of the inventive concept. In the drawings, the dimensions of layers and regions are exaggerated for clarity of illustration. Thus, the exemplary views may be modified according to manufacturing technology and/or allowable error. Therefore, the embodiments of the present invention are not limited to the specific shape illustrated in the exemplary views, but may include other shapes that may be created according to manufacturing processes. For example, an etched region described with right angles may be rounded or be configured with a predetermined curvature. Thus, the regions illustrated in figures are schematic, and shapes of the regions illustrated in figures exemplifies particular shapes of device regions, but do not limit the scope of the inventive concept.

Hereinafter, a companion animal weight care system and service method with electronic chart according to embodiments of the inventive concept will be described in detail with reference to the accompanying drawings.

The recommendation of acquaintances such as family, company colleagues, friends affect to select goods or services, a variety of purchasing are implemented through these recommendations.

Merchandisers' sale amount is increase with the recommendation. But, any benefit is not raised for a recommender who causes acquaintances' purchasing by the recommendation.

For example, when ‘A’ who wants to host a meeting near the Gangnam station requests ‘B’ requests a good place for the meeting to ‘B’ who has been host meetings frequently near the Gangnam station and the ‘B’ recommends the ‘alpha’ restaurant, there is no method to provide any benefit for ‘B’ even if the ‘B’ restaurant takes sales amount through the B's recommendation.

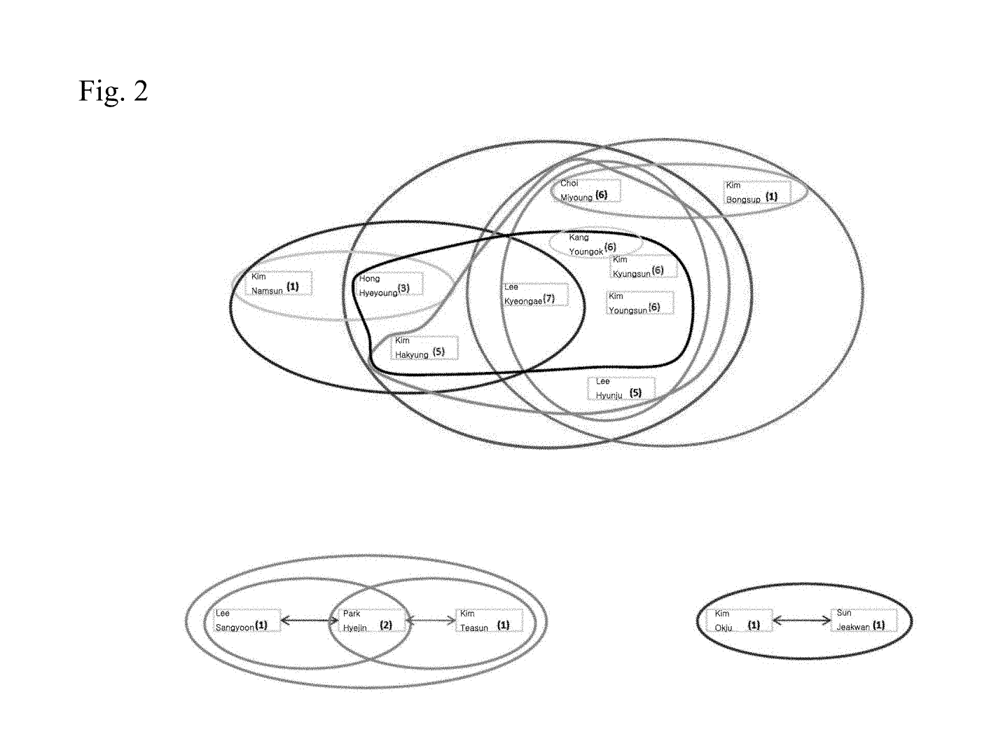

Specifically, as shown in FIG. 2, total guests can be classified into thirteen groups after analyzing personal connections of the total guests of certain franchise having 60 shops in Korea. Eight groups of them compose network with each other and other five groups have no relationship with each other. Thus, guests of the five groups do not compose a network.

Higher four groups of them are occupying 54% of total sale amount, and the eight groups which have network are occupying 80% of total sale amount.

80% of merchandiser's sale amount is obtained from purchasers having network. As a result of the analysis, the sales amount has been decreased at 14% when bad impression or uncomfortable service was given to customers who compose higher eight group occupying 80% of the sales amount. In contrast, the sales amount has been increased at 10% when good service was given to customers who compose higher eight group

According to inventive concept, the merchandiser pays the purchaser advertisement compensations about sales amount through the purchaser's network using characteristics of purchasers formed on the merchandiser member stores, but just sponsor authority for third parties as the advertisement compensation is granted to the purchaser.

The sponsor authority for third parties is just granted to the purchaser such that the sponsor (contribution) is implemented spontaneously in contrast to conventional method in which the merchandiser gives purchaser (recommender) point, goods and money as advertisement compensation.

There is a method that the merchandiser gives the purchaser available point as advertisement compensation to sponsor or contribute them to third parties. However, the inventive concept are given the purchaser just sponsor authority because the conventional method does not induce spontaneous sponsorship (contribution).

According to embodiments of the inventive concept, the purchaser is given point or money just available for providing third parties as advertisement compensation in proportion to sales amount occurring through acquaintances of the purchaser, the purchaser having a sponsor authority designates a target to sponsor then the merchandiser provides the advertisement compensation to the target.

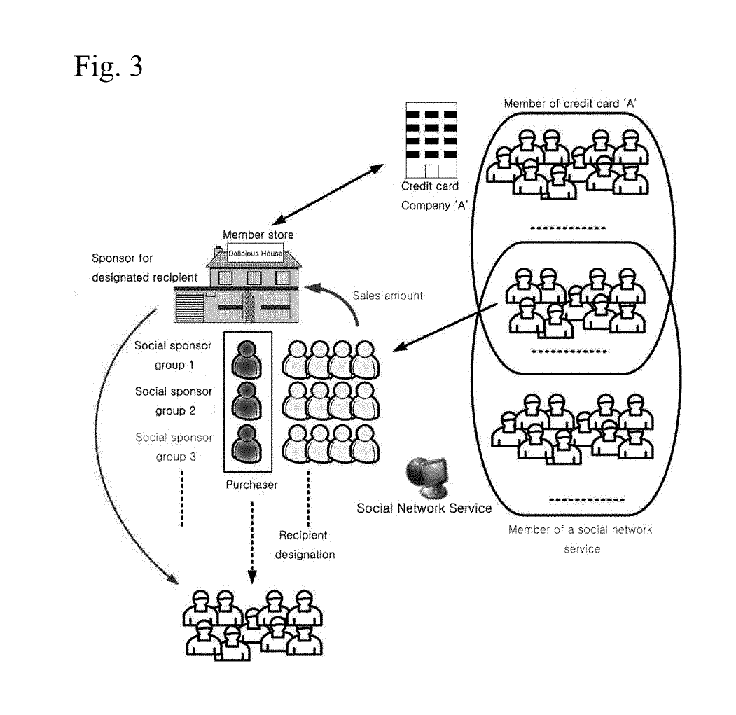

As shown in FIG. 3, in the inventive concept, a social sponsor group is composed through online personal connections (network) of a purchaser centering on an existing purchaser on the basis of a merchandising store (member store).

Particularly, credit card members who are a consumption group and social network service members who are a personal connection group are linked to compose the social sponsor group and to be database such that new type of consumption group, i.e., the social sponsor group is composed by the merchandizers (member stores). The new consumption group is composed with the purchaser, and the purchaser's social network acquaintances who have credit card membership of the same credit card company as the purchaser.

Thus, a social sponsor group with credit card of the same credit card company as the purchaser is composed by member stores and a portion of sales amount occurred from the social sponsor group is provided as advertisement compensations to the purchaser. The purchaser cannot use the advertisement compensation in person but have sponsor authority capable of providing toward third parties.

Although customers of the restaurant ‘Delicious house’ having a personal connection, such as family, colleagues or friends, compose substantially one social consumption group, the restaurant does not recognize that they are a consumption group with a personal connection, the customers with the personal connection, even if, do not specifically recognize that they compose the consumption group. In the inventive concept, a network of customer (social sponsor group) using the restaurant may be composed actually.

Therefore, the purchase has motivation to advertise the restaurant aggressively toward members of the social sponsor group, and more aggressive consumption may be implemented because the members of the social sponsor group can contribute to a recipient who is designated by a purchaser relating with the same members.

For example, the members of the purchaser's social sponsor group and a recipient designated by the purchaser, such as the a purchaser's friend, a fellow, parents of a friend, a friend of a senior/junior, an entertainer, an athlete, a colleague and an acquaintance in a serious situation, form a specific relationship through the purchaser having a social network relationship thereby encouraging aggressive participation (consumption through member stores)

Further, the restaurant can implement an after marketing to members of the actually composed social sponsor group such that effective marketing can be conducted with relatively low cost.

As shown in FIG. 3, the concrete method of composing the social sponsor group is that members having personal connection with a purchaser through a social network service and simultaneously being member of the ‘A’ credit card company compose a social sponsor group as a consumption group, by each members (purchasers) of the ‘A’ credit card company having used the restaurant ‘Delicious house’ which is a member store of the ‘A’ credit card company.

Social sponsor groups (Social sponsor group 1, 2, 3 . . . ) having relationship through a social network service with existing purchaser and having a credit card of the same credit card company as the existing purchaser are composed.

Although, just one credit card company and one social network service are described in FIG. 3, the inventive concept may be embodied in a plurality of credit card companies and one social network service, one credit card company and a plurality of social network services, and a plurality of credit card companies and a plurality of social network services.

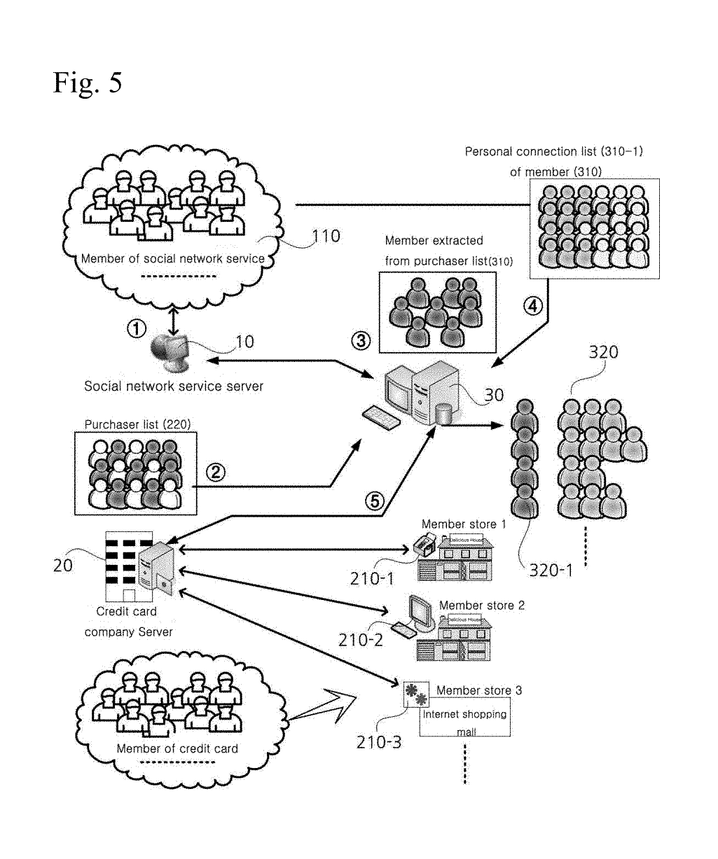

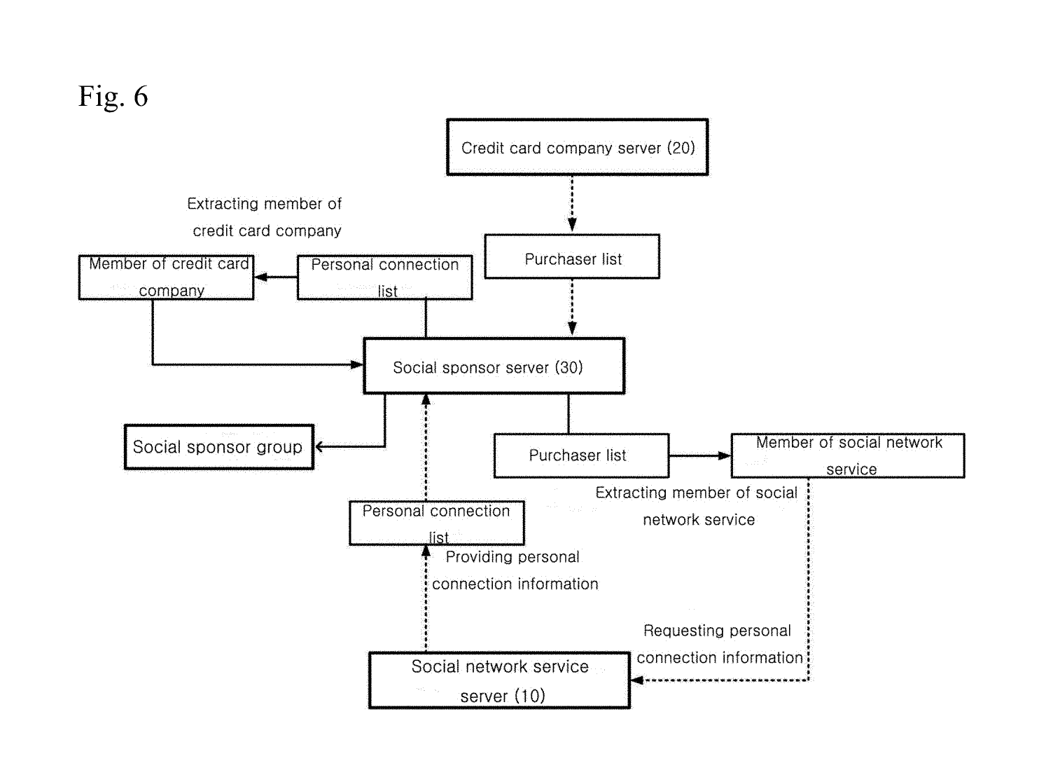

As shown in FIGS. 5 and 6, the novel method of composing social sponsor group by member stores to implement sponsorship includes a step of approving use of member information S10, a step of providing purchaser information S20, a step of identifying the member of the social network service S30, a step of providing personal connection information S40, a step of making social sponsor group by member stores S50, a step of permitting sponsor authority S60, a step of implementing social sponsorship S70.

In the step of approving use of member information S10, a procedure 0 for approving information utilization about members 110 of the social network service may be conducted through the social network service server 10. The social network service server 10 providing the social network service gets an approval for using the information necessary to social sponsorship from the members of the social network service.

The step of approving use of member information S10 is conducted as a method in which information for use of information necessary to social sponsor group service is provided to a member and the member agrees that. This step is conducted with conventional method such that a webpage of information use agreement is provided to member through the member's email or a smartphone message or at social network service login, and then the member agree with them.

The social network service server 10 may be variety of social network service servers provided by service suppliers who provide a service for composing personal connections, such as the nate on, MSN, twitter, facebook, cyworld and kakaotalk, or systems capable of personal connections such as contact list of the user.

After the step of approving use of member information S10, the step of providing purchaser information S20 is conducted such that a credit card company server 10 acquires credit card payment information from a credit card payment device 210 installed at a member store and transfers the purchaser information to the social sponsor server 30.

In the step of providing purchaser information S20, the credit card company server 20 acquires the credit card payment information form the credit card payment device 210 such as a credit card terminal 210-1, a POS system 210-2 or an internet credit card payment tool 201-3 installed on the member store (merchandising store) and transfers the purchaser information to the social sponsor server 30.

At this time, the purchaser information of each purchaser may be provided to the social sponsor server 30 each time, or purchaser list 220 which is information of credit card members (purchasers) paying with credit cards for a predetermined period by member stores may be formed to be sent to the social sponsor server 30.

The credit card company server 20 may be a server of a credit card company executing conventional credit card business, for example, a server operated on a credit card company which invites members of a credit card such as the BC card, the Hyundai card, the Kookmin card and the Lotte card and conducting a task for credit payment of them, may receive credit payment data from the credit card terminal 210-1, the POS system 210-2 and the internet credit card payment tool 210-3 installed on a plurality of member stores associated with the credit card company to execute payment approval and a series of data processing, and simultaneously, may communicate with the social sponsor server 30 to provide the purchaser information or the purchaser list information 220 by member stores in which purchasers paying with the credit card on each member store for a predetermined period are listed.

That is, using credit card payment information acquired form the offline member store 1 with the credit card terminal 210, the offline member store 2 with the POS system 210-1 and the online member store 3 with the internet credit card payment tool 210-2 embedded in an internet shopping mall, purchaser information or purchaser list information 220 of the member store 1, 2 and 3 may be transferred to the social sponsor server.

The purchaser information or the purchaser list information 220 may include product information or purchasing time information and payment amount information.

For example, if the merchandiser (member store) is online shopping mall selling books, the purchaser list may further include the product information, i.e., information about the book, or selling time and selling price of the book.

When the credit card server 20 generates the purchaser information or the purchaser list information 220, information of the member store, information of a product purchased at the member store, information of selling time and selling price may be included with information of member identification to be used as materials which are available to analyze consumption pattern of the purchaser and utilize as marketing information.

After the step of providing purchaser information S20, the step of identifying member of the social network service S30 is conducted. In the step of identifying member of the social network service S30, the social sponsor server 30 receiving the purchaser information is associated with the social network service server 10 to identify whether the purchaser is a member of the social network service

The step of identifying member of social network service S30 is a step to extract a purchaser joined to the social network service from purchasers. For identifying whether the purchaser use the social network service or not, the social sponsor server 30 may provide the social network service server 10 with information extract from the purchaser information provided from the credit card server 20. And the social network service server 10 receiving the information may identifying whether the purchaser is a member of the social network service or not.

If it is identified that the purchaser is a member of the social network service after the step of identifying member of the social network service, the step of providing purchaser's personal connection information S40 may be conducted such that the social network service server 10 provides the purchaser's personal connection information to the social sponsor server 30.

In the step of providing purchaser's personal connection information S40, the personal connection information on the social network of the purchaser paying with a credit card on the member store may be provide form the social network service server 10 to the social sponsor server 30.

The social network service server 10 may be a plurality of social network service servers providing a variety of social network services, and the social sponsor server 30 may receive the purchaser's personal connection information from the plurality of the social network service servers.

The step of providing purchaser's personal connection information S40 is conducted such that the social sponsor server 30 having the purchaser's personal connection information is associated with the credit card company server 20 to identify the social network service members whether the member of the credit card company. The social network service member is included in the personal connection (ex, personal connection list) provided from the social network service server 10. Then, the step of making social sponsor group S50 is conducted to composing a social sponsor group by member stores with members of the credit card company.

The step of making social sponsor group S50 is performed on the social sponsor server 30. The members of the credit card company are extracted from the social network service members included in the personal connection information (personal connection list) of the purchaser (a credit card member who is a member of the social network service) which was provided in the step S40 to assign as a social sponsor group of the purchaser by member stores.

In the step of making a social sponsor group by member stores S50, the social sponsor server 30 may be associated with the credit card company server 20 to identify whether the members in the purchaser's personal connection list 310-1 provided from the social network service server 10 are the credit card company member and to extract the credit card company member from the personal connection list \textcircled{5}.

The social sponsor server 30 may generate social sponsor group information of each purchaser by member stores using the information of the credit card company member personally connected with each purchaser to be database.

For example, if there are total thirty members of ten colleagues, five school friends, five family members and ten juniors on a NATEON account of the purchaser ‘Hong Kildong’ who paid with a credit card A at a restaurant B and twenty of them are members of the credit card A, the twenty members of the credit card A may compose a social sponsor group of Hong Kildong for the restaurant B (member store).

The twenty members of the credit card A may be the social sponsor group of Hong Kildong to be registered on the social sponsor server 30.

The social sponsor group information by member stores which is databased on the social sponsor server 30 may be provided to the member store and constituents in the social sponsor group, formation of the social sponsor group may be informed and updated information of the social sponsor group member may be informed to the constituents and the member store, continuously.

The constituent in the social sponsor group can recognize the social sponsor group for the member store, the existing purchaser who is a prime member at making the social sponsor group may advertise the merchandise store (member store) to its social sponsor group and aggressively advertise the merchandise store using an air or other online (blog, cafe, twitter and etc.).

The merchandise store may also recognize the social sponsor group to provide the social sponsor group with better service and benefit and to easily conduct member management and advertisement.

An example of method for providing the member store and constituents of the social sponsor group with the social sponsor group information through the social sponsor server 30 comprises logging in a webpage provided from the social sponsor server 30 with a predetermined identification number, for example a registration number such as a card number, a resident registration number, a membership number and a corporate registration number, providing logged member stores with the social sponsor group information of the member stores as a list form, and providing the constituents with the member store list and the social sponsor group information on each member store list.

As shown in FIG. 6, the credit card company server 20 may transfer the purchaser list to the social sponsor server 30.

The social sponsor server 30 may be associated with the social network service server 10 to extract the member of the social network service and requests personal connection information of the extracted member from the social network service server 10.

The social network service server 10 may provide the social sponsor server 30 with a personal connection list of the member.

The social sponsor server 30 may be associated with the credit card company server 20 to extract members of the credit card company from the members in the personal connection list, and compose the social sponsor group with the members of the social network service extracted from the purchaser list and the members of the credit card company extracted from the personal connection list. This social sponsor group is the social sponsor group of the purchaser.

The step of providing sponsor authority is performed at the social sponsor server 30. The advertisement compensation which is provided the purchaser from the member store is accumulated in the purchaser's sponsor account when the sales amount is occurred through credit payment of the social sponsor group by the member stores. And, the sponsor authority capable of contributing money accumulated in the sponsor account to third parties may be granted to the purchaser.

Therefore, when the social sponsor group 320 of FIG. 5 occurs sales amount at a member store, the member store provides money to the purchaser 320-1. However, the purchaser cannot use the money but just get a sponsor authority capable of contributing to third parties. The purchaser with the sponsor authority has the right of decision to select a sponsor target.

The advertisement compensation may be different in accordance with each goods on the member stores, or with social sponsor groups.

For example, the compensation of watches, earrings, rings and necklace are determine at respectively 3%, 5%, 7% and 10% to graduate the advertisement compensation by commodities such that the merchandiser can drive promotion for new commodities and commodities of event or sales depression.

If constituents of a social sponsor group buy usually watches, the advertisement compensation for watches is elevated from 3% to 5% such that aggressive merchandising or advertisement for watch can be achieved.

The advertisement compensation may be also determined according to total sales amount occurred by the social sponsor group within predetermined period to provide to the social sponsor group.

For example, in case that a merchandiser store provide advertisement compensation at 10% of monthly sales amount of the purchaser A's social sponsor group, the purchaser A gets 500 thousands Korean Won which can contribute to third parties if the sales amount for the purchaser A' social sponsor group is 5 hundreds Won.

In the step of implementing social sponsorship S70, a purchaser having the sponsor authority contributes money for a recipient. The purchaser inputs financial information (bank account number, credit card information) of the recipient through social sponsor server 30 to decide the recipient, the social sponsor server 30 contributes for the recipient decided by the purchaser according to the sponsor authority of the purchaser.

In the step of implementing social sponsorship S70, the purchaser decides a plurality of recipients through the social sponsor server 30 and sets contribution rate to the plurality of recipient thereby implanting the sponsorship.

For example, in case that a purchaser A designates parents B and a friend C as the recipient and set contribution rate into respectively 70% and 30%, the accumulated money by sales amount of the purchaser A's social sponsor group may be contributed to the parents B and the friend C at the predetermined contribution rate.

Thus, one social sponsor group can contribute a plurality of recipients according to the inventive concept.

If the recipient is a member of a credit card company, credit card settlement of the recipient may be treated with the sponsor money which was contributed by the purchaser.

For example, if the friend C is a member of a credit card company which is certified by the credit card company server 20, the settlement of the friend C can be treated by sponsor money of which the purchaser A contributes to the friend C.

In the step of implementing social sponsorship S70, the social sponsor server 30 may provide the purchaser with sponsor invitation information by which a recipient invites a sponsor such that a society or a person expecting sponsorship can request sponsorship from sponsors who are purchasers having the social sponsor group and sponsor authority.

For example, the society or the person expecting sponsorship provides a plurality of purchasers (sponsors) advertisement information of images or mails to request sponsorship from the purchaser having the sponsor authority.

The society expecting sponsorship may be a promoter managing an sponsorship event, an asylum, a welfare foundation and a professional sports team with a lot of fans, and the person expecting sponsorship may be a person necessary help and a sports athlete or an entertainer.

The social sponsor server 30 may provide other purchasers with the sponsor invitation information to invite sponsors for the recipient designated by the purchaser. Therefore, a sponsor contributing for some targets invites more sponsors to form a sponsor group such that more sponsorship can be achieved.

For example, a purchaser A with a social sponsor group can provide a plurality of purchasers with other social sponsor groups with advertisement images or mails suggesting contribution for an environment party to request sponsorship while the purchaser A contributes for the environment party.

The sponsor invitation information may be transferred from the social sponsor server 30 to a mobile terminal of the purchaser.

Accumulation information of the purchaser's sponsor account and sponsor information for the recipient designated by the purchaser may be transferred to the purchaser's mobile terminal from through the social sponsor server 30 in real time.

Therefore, the purchasers with the social sponsor group can see the state of sponsor money accumulated in their sponsor account and the state of sponsorship for the recipient, in real time.

The purchaser may registered a condition of the recipient through the social sponsor server 30, and the social sponsor server may select a sponsor requester in accordance with the condition of the recipient to provide the purchaser with information of sponsor requester. Therefore, the purchaser can look for a sponsor requester who is appropriate for the purchaser desire by matching the purchaser and the sponsor request.

For example, in case that the purchaser registers welfare family/working student/elementary school student as the condition of recipient on the social sponsor server 30, the social sponsor server 30 may extract a sponsor requester under the condition of recipient from the registered sponsor requests to provide the purchaser with information of the sponsor requesters.

The above-disclosed subject matter is to be considered illustrative and not restrictive, and the appended claims are intended to cover all such modifications, enhancements, and other embodiments, which fall within the true spirit and scope allowed by law, the scope of the inventive concept is to be following claims and their equivalents, and shall not be restricted or limited by the foregoing detailed description.

What is claimed is:

1. A social sponsor method using a social network service and credit card payment information comprising:
a step of approving use of member information in which a social network service server providing a social network service obtains an approval for using information necessary to a social sponsor from members of the social network service;
a step of providing purchaser information in which a credit card company server obtains credit card payment information from a credit card payment device installed in a member store and transfers the purchaser information to the social sponsor server;
a step of identifying the member of the social network service in which the social sponsor server associates with the social network service server and requests identification of the social network service server whether the purchaser is a member of the social network service;
a step of providing personal connection information of the purchaser in which the social network service server transfers the personal connection information to the social sponsor server if the purchaser is identified as a member;
a step of making social sponsor group by member stores in which the social sponsor server associates with the credit card company server to identify the member of the social network service contained in the personal connection information received from the social network service server as a member of the credit card company;
a step of permitting sponsor authority in which the social sponsor server accumulates advertising compensation into a purchaser's sponsor account, and provides the purchaser with the sponsor authority, wherein the advertising compensation provided by a member store to the purchaser when sales amount arises by a credit card payment in the social sponsor group of each member store; and
a step of implementing social sponsorship in which the purchaser having the sponsor authority selects a recipient through the social sponsor server and the social sponsor server assists the recipient selected by the purchaser in accordance with the sponsor authority of the purchaser.

2. The method of claim 1, wherein the social network service server is a plurality of social network service servers providing variety of social network services; and
wherein the social sponsor server receives personal connection information of the purchaser from a plurality of the social network service servers.

3. The method of claim 1, wherein a credit card payment device in the step of providing purchase information comprises at least one of a credit card terminal, a point of sales (POS) system and an internet credit card payment application.

4. The method of claim 1, wherein the step of making a social sponsor group by member stores further comprises that the social sponsor server generates the social sponsor group of purchasers by member stores to construct a database of a social sponsor group information and transfers the database of social sponsor group information to a credit card company members and member stores in the social sponsor group through the social sponsor server, the database.

5. The method of claim 1, wherein the advertisement compensation in the step of permitting sponsor authority is decided based on total purchasing amount of the social sponsor group in the member store during predetermined period.

6. The method of claim 1, wherein the step of implementing social sponsorship comprises that the purchaser designates a plurality of recipients through the social sponsor server and designates sponsorship rates of the recipients such that sponsorship is implemented in accordance with the sponsorship rate.

7. The method of claim 1, wherein the step of implementing social sponsorship comprises that sponsorship money is settled the credit card payments of the recipient when the recipient is a member of a credit card company.

8. The method of claim 1, wherein the step of implementing social sponsorship comprises that information of advertisement for sponsors which is provided by the recipient in order to invite sponsors is provided to the purchasers through the social sponsor server.

9. The method of claim 1, wherein in the step of implementing social sponsorship, information of advertisement for sponsors is provided to other purchasers in order to invite sponsors for a recipient designated by the sponsor.

10. The method of claim 8 or 9, wherein the social sponsor server transfers the information of advertisement for sponsor to a mobile terminal of the purchaser.

11. The method of claim 1, wherein the step of implementing social sponsorship comprises that accumulation information of a sponsor account and sponsorship information for recipient designated by a purchaser is provided to the purchaser's mobile terminal through the social sponsor server in real time.

12. The method of claim 1, wherein, the step of implementing social sponsorship comprises that a purchaser specifies condition for recipients through the social sponsor server, and the social sponsor server links the purchaser and a sponsorship requester in accordance with the specified condition for the recipients to provide the purchaser with information of the sponsorship requester.
